(19) United States
(12) Patent Application Publication
(10) Pub. No.: US 2014/0156276 A1
(43) Pub. Date: Jun. 5, 2014

(54) CONVERSATION SYSTEM AND A METHOD FOR RECOGNIZING SPEECH

(71) Applicant: Honda Motor Co., Ltd., Tokyo (JP)

(72) Inventors: Mikio NAKANO, Wako-shi (JP); Kauznori KOMATANI, Nagoya-shi (JP); Akira HIRANO, Nagoya-shi (JP)

(73) Assignee: Honda Motor Co., Ltd., Tokyo (JP)

(21) Appl. No.: 13/900,997

(22) Filed: May 23, 2013

(30) Foreign Application Priority Data
Oct. 12, 2012 (JP) 2012-227014

(51) Int. Cl. G10L 15/02

(52) U.S. Cl. CPC G10L 15/02
USPC 704/246

(57) ABSTRACT

A dialogue system which correctly identifies an utterance directed to a dialogue system by using various pieces of information including information other than a voice recognition result without requiring a special signal is provided.

A dialogue system includes an utterance detection/voice recognition unit that detects an utterance and recognizes a voice and an utterance feature extraction unit that extracts features of an utterance. The utterance feature extraction unit determines whether or not a target utterance is directed to the dialogue system based on features including a length of the target utterance, time relation between the target utterance and a previous utterance, and a system state.

### BACKGROUND

1. Technical Field

The present invention relates to a dialogue system and a determination method of an utterance to the dialogue system.

2. Related Art

Basically, the dialogue system should respond to an inputted utterance. However, the dialogue system should not respond to a monologue and an interjection of a talker (user). For example, when the user conducts a monologue during a dialogue, if the dialogue system makes a response such as listening again, the user needs to uselessly respond to the response. Therefore, it is important for the dialogue system to correctly determine an utterance directed to the dialogue system.

In a conventional dialogue system, a method is employed in which an input shorter than a certain utterance length is deemed to be a noise and ignored (Lee, A., Kawahara, T.: Recent Development of Open-Source Speech Recognition Engine Julius, in Proc. APSIPAASC, pp. 131-137 (2009)). Further, a study is performed in which an utterance directed to a dialogue system is detected by using linguistic characteristics and acoustic characteristics of a voice recognition result and utterance information of other speakers (Yamagata, T., Sako, A., Takiguchi, T., and Ariki, Y.: System request detection in conversation based on acoustic and speaker alternation features, in Proc. INTER-SPEECH, pp. 2789-2792 (2007)). Generally, a determination of whether or not to deal with an utterance inputted into a conventional dialogue system is made from a viewpoint of whether or not the voice recognition result is correct. On the other hand, a method is developed in which a special signal that indicates an utterance directed to a dialogue system is transmitted to the dialogue system (Japanese Unexamined Patent Application Publication No. 2007-121579).

However, a dialogue system and a recognition method which correctly identify an utterance directed to the dialogue system by using various pieces of information including information other than the utterance length and the voice recognition result without requiring a special signal have not been developed.

### SUMMARY

Therefore, there is a need for a dialogue system and a recognition method which correctly identify an utterance directed to the dialogue system by using various pieces of information including information other than the utterance length and the voice recognition result without requiring a special signal.

A dialogue system according to a first aspect of the present invention includes an utterance detection/voice recognition unit configured to detect an utterance and recognizes a voice; and an utterance feature extraction unit configured to feature of an utterance. The utterance feature extraction unit determines whether or not a target utterance is directed to the dialogue system based on features including a length of the target utterance, time relation between the target utterance and a previous utterance, and a system state.

The dialogue system according to this aspect determines whether or not the target utterance is directed to the dialogue system by considering the time relation between the target utterance and the previous utterance and the system state in addition to the length of the target utterance, so that it is possible to perform the determination at a higher degree of accuracy compared with a case in which the determination is performed by using only the length of the target utterance.

In the dialogue system according to a first embodiment of the present invention, the features further include features obtained from utterance content and voice recognition result.

The dialogue system according to the present embodiment determines whether or not the target utterance is directed to the dialogue system by considering the features obtained from the utterance content and the voice recognition result, so that it is possible to perform the determination at a higher degree of accuracy when the voice recognition functions successfully.

In the dialogue system according to a second embodiment of the present invention, the utterance feature extraction unit performs determination by using a logistic function that uses normalized features as explanatory variables.

The dialogue system according to the present embodiment uses the logistic function, so that training for the determination can be done easily. Further, feature selection can be performed to further improve the determination accuracy.

In the dialogue system according to a third embodiment of the present invention, the utterance detection/voice recognition unit is configured to merge utterances with a silent section shorter than or equal to a predetermined time period in between into one utterance.

The dialogue system according to the present embodiment is configured to merge utterances with a silent section shorter than or equal to a predetermined time period in between into one utterance, so that an utterance section can be reliably detected.

A determination method according to a second aspect of the present invention is a determination method in which a dialogue system including an utterance detection/voice recognition unit and an utterance feature extraction unit determines whether or not an utterance is directed to the dialogue system. The determination method includes a step in which the utterance detection/voice recognition unit detects an utterance and recognizes a voice and a step in which the utterance feature extraction unit determines whether or not a target utterance is directed to the dialogue system based on features including a length of the target utterance, time relation between the target utterance and a previous utterance, and a system state.

The determination method according to this aspect determines whether or not the target utterance is directed to the dialogue system by considering the time relation between the target utterance and the previous utterance and the system state in addition to the length of the target utterance, so that it is possible to perform the determination at a higher degree of accuracy compared with a case in which the determination is performed by using only the length of the target utterance.

### BRIEF DESCRIPTION OF DRAWINGS

FIG. 1 is a diagram showing a configuration of a dialogue system according to an embodiment of the present invention;

FIG. 2 is a diagram for explaining a length of an utterance (utterance length)

FIG. 3 is a diagram for explaining an utterance time interval;

FIG. 4 is a diagram showing an example in which x₄ is equal to 1;

FIG. 5 is a diagram showing an example of a usual barge-in in which a system utterance is interrupted by an utterance of a user;

FIG. 6 is a flowchart showing an operation of the dialogue system according to the embodiment of the present invention; and

FIG. 7 is a flowchart showing a procedure of feature selection.

### DETAILED DESCRIPTION

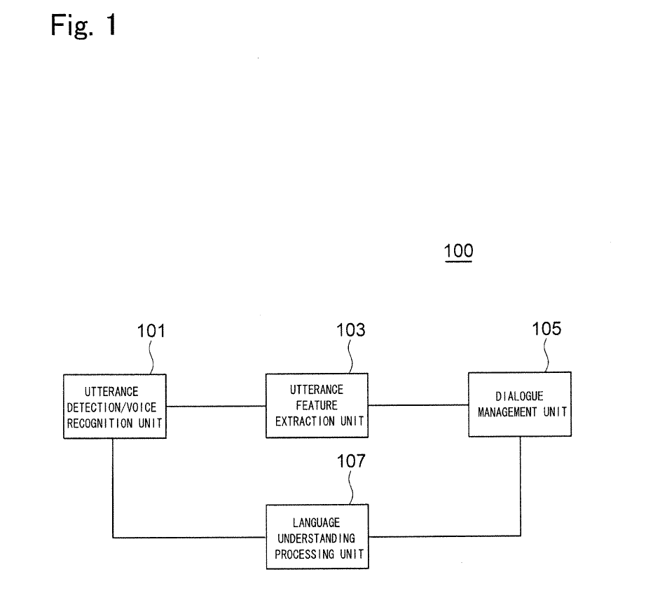

FIG. 1 is a diagram showing a configuration of a dialogue system 100 according to an embodiment of the present invention. The dialogue system 100 includes an utterance detection/voice recognition unit 101, an utterance feature extraction unit 103, a dialogue management unit 105, and a language understanding processing unit 107. The utterance detection/voice recognition unit 101 performs detection of an utterance of a user (talker) and voice recognition at the same time. The utterance feature extraction unit 103 extracts features of the utterance of the user detected by the utterance detection/voice recognition unit 101 and determines whether or not the utterance of the user is directed to the dialogue system 100. The utterance detection/voice recognition unit 101 and the utterance feature extraction unit 103 will be described later in detail. The language understanding processing unit 107 performs processing to understand content of the utterance of the user based on a voice recognition result obtained by the utterance detection/voice recognition unit 101. The dialogue management unit 105 performs processing to create a response to the user for the utterance determined to be an utterance directed to the dialogue system 100 by the utterance feature extraction unit 103 based on the content obtained by the language understanding processing unit 107. A monologue, an interjection, and the like of the user are determined not to be an utterance directed to the dialogue system 100 by the utterance feature extraction unit 103, so that the dialogue management unit 105 does not create a response to the user. Although the dialogue system 100 further includes a language generation processing unit that generates a language for the user and a voice synthesis unit that synthesizes a voice of the language for the user, FIG. 1 does not show these units because these units have nothing to do with the present invention.

The utterance detection/voice recognition unit 101 performs utterance section detection and voice recognition by decoder-VAD mode of Julius as an example. The decoder-VAD of Julius is one of options of compilation implemented by Julius ver. 4 (Akinobu Lee, Large Vocabulary Continuous Speech Recognition Engine Julius ver. 4. Information Processing Society of Japan, Research Report, 2007-SLP-69-53. Information Processing Society of Japan, 2007.) and performs the utterance section detection by using a decoding result. Specifically, as a result of decoding, if a maximum likelihood result is that silent word sections continue a certain number of frames or more, the sections are determined to be a silent section, and if a word in a dictionary is maximum likelihood, the word is employed as a recognition result (Hiroyuki Sakai, Tobias Cincarek, Hiromichi Kawanami, Hiroshi Saruwatari, Kiyohiro Shikano, and Akinobu Lee, Speech Section Detection and Recognition Algorithm Based on Acoustic And Language Models for Real-Environment Hands-Free Speech Recognition (the Institute of Electronics, Information and Communication Engineers Technical Report. SP, Speech, Vol. 103, No. 632, pp. 13-18, 2004-01-22.)). As a result, the utterance section detection and the voice recognition are performed at the same time, so that it is possible to perform accurate utterance section detection without depending on parameters set in advance such as an amplitude level and the number of zero crossings.

The utterance feature extraction unit 103 first extracts features of an utterance. Next, the utterance feature extraction unit 103 determines acceptance (an utterance directed to the system) or rejection (an utterance not directed to the system) of a target utterance. As an example, specifically, the utterance feature extraction unit 103 uses a logistic regression function described below, which uses each feature as an explanatory variable.

[Formula 1]

P(x₁, . . . , xᵣ)=1/(1+exp(−(a₀+a₁x₁+ . . . +aᵣxᵣ))) (1)

As objective variables of the logistic regression function, 1 is assigned to the acceptance and 0 is assigned to the rejection. Here, xₖ is a value of each feature described below, aₖ is a coefficient of each feature, and a₀ is a constant term.

Table 1 is a table showing a list of the features. In Table 1, xᵢ represents a feature. For the features, only information obtained by the utterance is used to use the features in an actual dialogue. Values of features whose section is not determined are normalized so that average is 0 and distribution is 1 after the values are calculated.

TABLE 1

| | |
|---|---|
| Length of utterance | x₁: Utterance length |
| Time relation with | x₂: Interval |
| previous utterance | x₃: Continuous user utterances |
| | x₄: Included barge-in |
| | x₅: Barge-in timing |
| System state | x₆: System state |
| utterance content | x₇: Response |
| | x₈: Request |
| | x₉: Stop request |
| | x₁₀: Filler |
| | x₁₁: Content word |
| Feature obtained | x₁₂: Acoustic likelihood difference |
| from voice | score |
| recognition | |

### Length of Utterance

The length of the inputted utterance is represented by x₁. The unit is second. The longer the utterance is, the more probable that the utterance is purposefully made by the user.

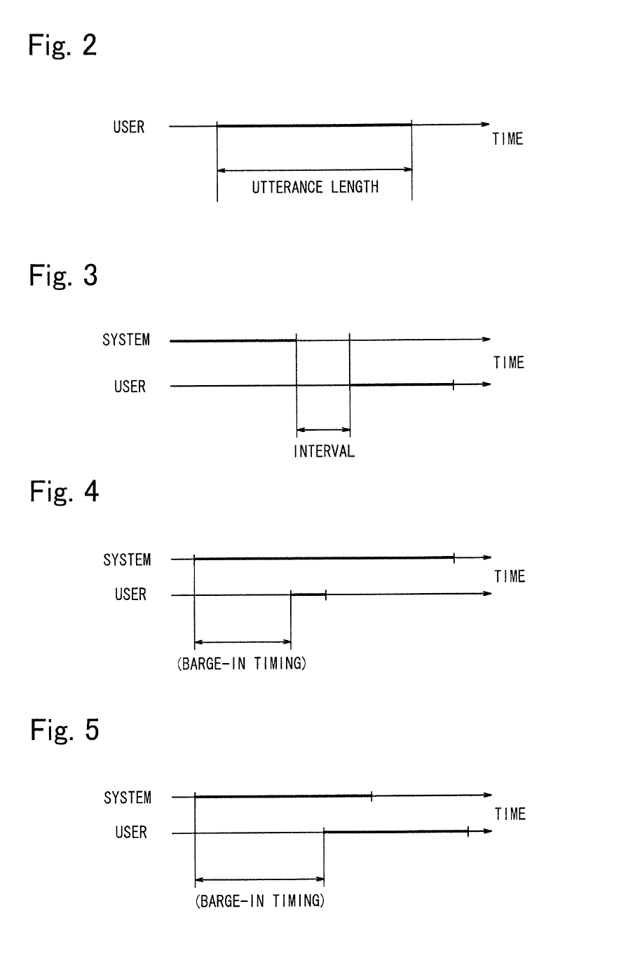

FIG. 2 is a diagram for explaining the length of an utterance (utterance length). In FIGS. 2 to 5, a thick line represents an utterance section and a thin line represents a non-utterance section.

Time Relation with Previous Utterance

The features x₂ to x₅ represent time relation between a current target utterance and a previous utterance. The feature x₂ is an utterance time interval and is defined as a difference between the start time of the current utterance and the end time of the previous system utterance. The unit is second.

FIG. 3 is a diagram for explaining the utterance time interval.

The feature x₃ represents that a user utterance continues. That is to say, x₃ is set to 1 when the previous utterance is made by the user. One utterance is recognized by delimiting utterance by silent sections having a certain length, so that a user utterance and a system utterance often continue.

The features x₄ and x₅ are features related to barge-in. The barge-in is a phenomenon in which the user interrupts and starts talking during an utterance of the system. The feature x₄ is set to 1 if the utterance section of the user is included in the utterance section of the system when the barge-in occurs. In other words, this is a case in which the user interrupts the utterance of the system, however, the user stops talking before the system stops the utterance. The feature x₅ is barge-in timing. The barge-in timing is a ratio of time from the start time of the system utterance to the start time of the user utterance to the length of the system utterance. In other words, x₅ represents a time point at which the user interrupts during the system utterance by using a value between 0 and 1 with 0 being the start time of the system utterance and 1 being the end time of the system utterance.

FIG. 4 is a diagram showing an example in which x₄ is equal to 1. A monologue and an interjection of the user correspond to this example.

FIG. 5 is a diagram showing an example of a usual barge-in in which the system utterance is interrupted by the utterance of the user. In this case, x₄ is equal to 0.

### State of System

The feature x₅ represents a state of the system. The state of the system is set to 1 when the previous system utterance is an utterance that gives a turn (voice) and set to 0 when the previous system utterance holds the turn.

Table 2 is a table showing an example of the system utterances that give the turn or hold the turn. Regarding the first and the second utterances, the response of the system continues, so that it is assumed that the system holds the turn. On the other hand, regarding the third utterance, the system stops talking and asks a question to the user, so that it is assumed that the system gives voice to the user. The recognition of the holding and giving is performed by classifying 14 types of tags provided to the system utterances.

TABLE 2

| Utterance | Time of | | |
|---|---|---|---|
| number | utterance | Utterer | Content of utterance |
| 1 | 81.66-82.32 | S | Excuse me (holding) |
| 2 | 83.01-84.13 | S | I didn't get it (holding) |
| 3 | 84.81-88.78 | S | Could you ask me that |
| | | | question once more in |
| | | | another way? (giving) |
| 4 | 89.29-91.81 | U | Please tell me about the |
| | | | World Heritage Sites in |
| | | | Greece |

In Table 2,
S and U represent the system and the user respectively.
“xx-yy” represents the start time and the end time (unit: second) of the utterance.

### Content of Utterance (Linguistic Representation of Utterance)

The features x₇ to x₁₁ represent that the representations of the utterances include the representations described below. The feature x₇ is set to 1 when 11 types of representations, such as “Yes”, “No”, and “It's right”, which represent a response to the utterance of the system, are included. The feature x₈ is set to 1 when a representation of a request such as “Please tell me” is included. The feature x₉ is set to 1 when a word “end”, which stops a series of explanations by the system, is included. The feature x₁₀ is set to 1 when representations, such as “let's see” and “Uh”, which represent a filler, are included. Here, the filler is a representation that shows a mental information processing operation of a talker (user) during the dialogue. Here, 21 types of fillers are prepared manually. The feature x₁₁ is set to 1 when any one of 244 words which represent a content word is included and otherwise the x₁₁ is set to 0. The content word is a proper noun, such as a region name and a building name, which is used in the system.

### Feature Obtained From Voice Recognition Result

The feature x₁₂ is a difference of acoustic likelihood difference score between a voice recognition result of the utterance and a verification voice recognition device (Komatani, K., Fukubayashi, Y., Ogata, T., and Okuno, H. G.,: Introducing Utterance Verification in Spoken Dialogue System to Improve Dynamic Help Generation for Novice Users, in Proc. 8th SIGdial Workshop on Discourse and Dialogue, pp. 202-205 (2007)). As a language model of the verification voice recognition device, a language model (vocabulary size is 60,000) is used which is learned from a web and which is included in a Julius dictation implementation kit). A value obtained by normalizing the above difference by the utterance length is used as the feature.

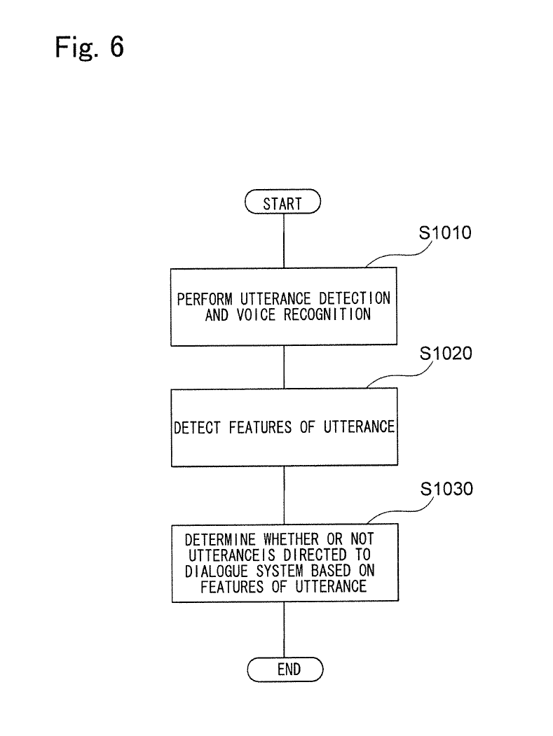

FIG. 6 is a flowchart showing an operation of the dialogue system according to the embodiment of the present invention.

In step S1010 in FIG. 6, the utterance detection/voice recognition unit 101 performs utterance detection and voice recognition.

In step S1020 in FIG. 6, the utterance feature extraction unit 103 extracts features of the utterance. Specifically, the values of the above x₁ to x₁₂ are determined for the current utterance.

In step S1030 in FIG. 6, the utterance feature extraction unit 103 determines whether or not the utterance is directed to the dialogue system based on the features of the utterance. Specifically, the utterance feature extraction unit 103 determines the acceptance (an utterance directed to the system) or the rejection (an utterance not directed to the system) of the target utterance by using the logistic regression function of Formula (1).

An evaluation experiment of the dialogue system will be described below.

First, target data of the evaluation experiment will be described. In the present experiment, dialogue data collected by using a spoken dialogue system (Nakano, M., Sato, S., Komatani, K., Matsuyama, K., Funakoshi, K., and Okuno, H. G. A Two-Stage Domain Selection Framework for Extensible Multi-Domain Spoken Dialogue Systems, in Proc. SIGDAL Conference, pp. 18-29 (2011)) is used. Hereinafter, a method of collecting data and a creation criterion of transcription will be described. The users are 35 men and women from 19 to 57 years old (17 men and 18 women). An eight-minute dialogue is recorded four times per person. The dialog method is not designated in advance and the users are instructed to have a free dialogue. As a result, 19415 utterances (user: 5395 utterances, dialogue system: 14020 utterances) are obtained. The transcription is created by automatically delimiting collected voice data by a silent section of 400 milliseconds. However, even if there is a silent section of 400 milliseconds or more such as a double consonant in a morpheme, the morpheme is not delimited and is included in one utterance. A pause shorter than 400 milliseconds is represented by inserting <p> at the position of the pause. 21 types of tags that represent the content of the utterance (request, response, monologue, and the like) are manually provided for each utterance.

The unit of the transcription does not necessarily correspond to the unit of the purpose of the user for which the acceptance or the rejection should be determined. Therefore, preprocessing is performed in which continuous utterances with a short silent section in between are merged and assumed as one utterance. Here, it is assumed that the end of utterance can be correctly recognized by another method (for example, Sato, R., Higashinaka, R., Tamoto, M., Nakano, M. and Aikawa, K.: Learning decision trees to determine turn-taking by spoken dialogue systems, in Proc. ICSLP (2002)). The preprocessing is performed separately for the transcription and the voice recognition result.

Regarding the transcription, among the tags provided to the utterances of the user, there is a tag indicating that an utterance is divided into a plurality of utterances, so that if such a tag is provided, two utterances are merged into one utterance. As a result, the number of the user utterances becomes 5193. Provision of correct answer label of acceptance or rejection is performed also based on the user utterance tags provided manually. As a result, the number of accepted utterances is 4257 and the number of rejected utterances is 936.

On the other hand, regarding the voice recognition result, utterances where a silent section between the utterances is 1100 milliseconds or less are merged. As a result, the number of the utterances becomes 4298. The correct answer label for the voice recognition result is provided based on a temporal correspondence relationship between the transcription and the voice recognition result. Specifically, when the start time or the end time of the utterance of the voice recognition result is within the section of the utterance in the transcription, it is assumed that the voice recognition result and the utterance in the transcription data correspond to each other. Thereafter, the correct answer label in the transcription data is provided to the corresponding voice recognition result.

Table 3 is a table showing the numbers of utterances in the experiment. The reason why the number of utterances in the voice recognition result is smaller than the number of utterances in the transcription is because pieces of utterance are merged with the previous utterance or the next utterance and there are utterances where the utterance section is not detected in the voice recognition result among the utterances transcribed manually.

TABLE 3

| | Acceptance | Rejection | Total |
|---|---|---|---|
| Transcription | 4257 | 936 | 5193 |
| Voice recognition result | 4096 | 202 | 4298 |

Next, the condition of the evaluation experiment will be described. The evaluation criterion of the experiment is a degree of accuracy to correctly determine an utterance to be accepted and an utterance to be rejected. For the implementation of the logistic regression, “weka.classifiers.functions.Logistic” (Hall, M., Frank, E., Holmes, G., Pfharinger, B., Reutemann, P., and Witten, I., H.: The WEKA data mining software: an update, SIGKDDExplor.News1., Vol. 97, No. 1-2, pp. 10-18 (2009)) is used. The coefficient aₖ in Formula (1) is estimated by 10-fold cross-validation. In the learning data, there is a difference between the number of utterances to be accepted and the number of utterances to be rejected, so that the learning and the evaluation are performed by providing corresponding weight to a ratio of the number of utterances with respect to the rejection. Therefore, the majority baseline is 50%.

As experiment conditions, the four experiment conditions described below are set.

1. Case in which only the Utterance Length is used

The determination is performed by using only the feature x₁. This corresponds to a case in which an option -rejectshort of the voice recognition engine Julius is used. This is a method that can be easily implemented, so that this is used as one of the baselines. The threshold value of the utterance length is determined so that the determination accuracy is the highest for the learning data. Specifically, the threshold value is set to 1.10 seconds for the transcription and is set to 1.58 seconds for the voice recognition result. When the utterance length is longer than these threshold values, the utterance is accepted.

2. Case in which all the Features are used

The determination is performed by using all the features listed in Table 1. In the case of transcription, all the features except for the feature (x₁₂) obtained from the voice recognition are used.

3. Case in which the Features Unique to the Spoken Dialogue System are Removed

This is a case in which the features unique to the spoken dialogue system, that is, the features x₂ to x₆ are removed from the case in which all the features are used. This condition is defined as another baseline.

4. Case in which Feature Selection is Performed

This is a case in which features are selected from all the available features by backward stepwise feature selection (Kohavi, R., and John, G. H.: Wrappers for feature subset selection, Artificial Intelligence, Vol. 97, No. 1-2, pp. 273-324 (1997)). Specifically, this is a result when a procedure, in which the determination accuracy is calculated by removing a feature one by one, and if the determination accuracy is not degraded, the feature is removed, is repeated until the determination accuracy is degraded when any feature is removed.

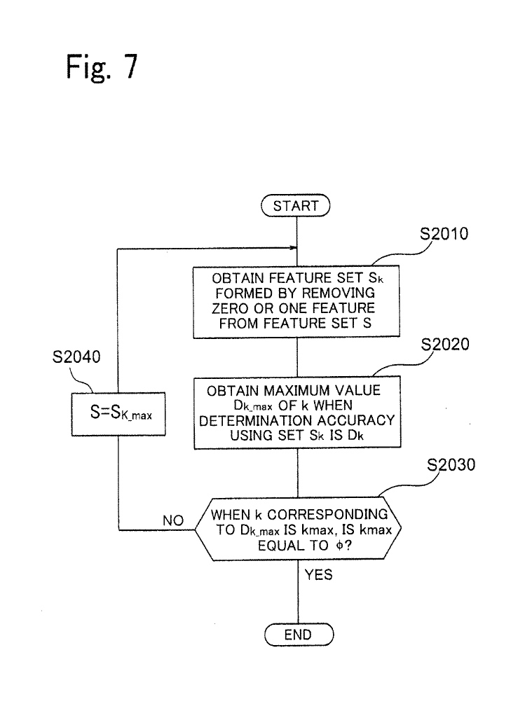

FIG. 7 is a flowchart showing a procedure of the feature selection.

In step S2010 in FIG. 7, a feature set obtained by removing zero or one feature from a feature set S is defined as a feature set Sₖ. Here, k represents a feature number of the removed feature. When the number of the features is n, k is an integer from 1 to n. However, when no feature is removed, k is defined as k=φ.

In step S2020 in FIG. 7, when the determination accuracy using the set Sₖ is Dₖ, the maximum value Dₖ_{_{—}}ₘₐₓ of k is obtained.

In step S2030 in FIG. 7, when k corresponding to Dₖ_{_{—}}ₘₐₓ is kmax, it is determined whether kmax is equal to φ. If the determination result is YES, the process is completed. If the determination result is NO, the process proceeds to step S2040.

In step S2040 in FIG. 7, S=Sₖ_{_{—}}ₘₐₓ is set and the process returns to step S2010. Here, Sₖ_{_{—}}ₘₐₓ is a feature set obtained by removing a feature of feature number kmax form the current feature set.

Next, the determination performance for the transcription data will be described. The determination accuracy is calculated for the 5193 user utterances (acceptance: 4257, rejection: 936) described in Table 3 by the 10-fold cross-validation. Considering the deviation of the correct answer labels, the learning is performed by providing weight of 4.55 (=4257/936) to the utterances to be rejected.

Table 4 is a table showing the determination accuracy for the transcription data in the four experiment conditions. When all the features are used, the determination accuracy is higher than when the features unique to the spoken dialogue system are removed. For this reason, it is known that the determination accuracy is improved by the features unique to the spoken dialogue system. As a result of the feature selection, the features x₃ and x₅ are removed. When comparing the baseline using only the utterance length and the case in which the feature selection is performed, the determination accuracy is improved by 11.0 points as a whole.

TABLE 4

| | |
|---|---|
| Case in which feature selection is performed | 85.4% |
| Case in which all the features are used | 85.1% |
| Case in which the features unique to the spoken | 84.2% |
| dialogue system are removed | |
| Case in which only the utterance length is used | 74.4% |

Next, the determination accuracy for the voice recognition result will be described. The determination accuracy is also calculated for the 4298 voice recognition results of user utterances (acceptance: 4096, rejection: 202) by the 10-fold cross-validation. Julius is used for the voice recognition. The vocabulary size of the language model is 517 utterances and the phoneme accuracy rate is 69.5%. Considering the deviation of the correct answer labels, the learning is performed by providing weight of 20.3 (=4096/202) to the rejection.

Table 5 is a table showing the determination accuracy for the voice recognition result in the four experiment conditions. In the same manner as in the case of transcription data, when all the features are used, the determination accuracy is higher than when the features unique to the spoken dialogue system are removed. The difference is statistically significant by McNemar s test. This indicates that the features of the spoken dialogue system are dominant to determine the acceptance or rejection. In the feature selection, five features x₃, x₇, x₉, x₁₀, and x₁₂ are removed.

TABLE 5

| | |
|---|---|
| Case in which feature selection is performed | 76.7% |
| Case in which all the features are used | 76.0% |
| Case in which the features unique to the spoken | 74.5% |
| dialogue system are removed | |
| Case in which only the utterance length is used | 72.6% |

Table 6 is a table showing the characteristics of the coefficients of the features. Regarding the features where the coefficient aₖ is positive, when the value of the feature is 1, or the greater the value of the feature is, the greater the tendency that the utterance is accepted. Regarding the features where the coefficient aₖ is negative, when the value of the feature is 1, or the greater the value of the feature is, the greater the tendency that the utterance is rejected. For example, the coefficient of the feature x₅ is positive, so that if the barge-in occurs in the latter half of the system utterance, the probability that the acceptance is determined is high. The coefficient of the feature x₄ is negative, so that if the utterance section of the user is included in the utterance section of the system, the probability that the rejection is determined is high.

TABLE 6

| | |
|---|---|
| Coefficient aₖ is positive | x₁, x₅, x₆, x₈, x₁₁ |
| Coefficient aₖ is Negative | x₂, x₄ |
| Removed by the feature selection | x₃, x₇, x₉, x₁₀, x₁₂ |

When comparing Table 4 and Table 5, the determination accuracy for the voice recognition result is lower than the determination accuracy for the transcription data. This is due to voice recognition errors. Further, in the determination for the voice recognition result, the features (x₇, x₉, and x₁₀) representing the utterance content are removed by the feature selection. These features strongly depend on the voice recognition result. Therefore, the features are not effective when many voice recognition errors occur, so that the features are removed by the feature selection.

For example, if a filler of the user who is talking to the dialogue system is determined to include a content word due to a voice recognition error, the probability that the acceptance is determined for the filler is high if this goes on. Here, if the user utterance starts in the first half of the system utterance, the value of the feature x₅ is small. If the utterance section of the user utterance is included in the utterance section of the system utterance, the value of the feature x₄ is 1. In the spoken dialogue system, these features unique to the spoken dialogue system are used, so that ever if a filler is falsely recognized, the rejection can be determined. The features unique to the spoken dialogue system do not depend on the voice recognition result, so that even if the voice recognition result tends to be error prone, the features unique to the spoken dialogue system are effective to determine the utterances.

In the dialogue system of the present embodiment, the determination of acceptance or rejection is performed by using the features unique to the dialogue system, such as time relation with a previous utterance and a state of the dialogue. When the features unique to the dialogue system are used, the determination rate of acceptance or rejection is improved by 11.4 points for the transcription data and 4.1 points for the voice recognition result compared with the baseline that uses only the utterance length.

What is claimed is:

1. A dialogue system comprising:
an utterance detection/voice recognition unit configured to detect an utterance and recognizes a voice; and
an utterance feature extraction unit configured to extract features of an utterance,
wherein the utterance feature extraction unit determines whether or not a target utterance is directed to the dialogue system based on features including a length of the target utterance, time relation between the target utterance and a previous utterance, and a system state.

2. The dialogue system according to claim 1, wherein the features further include features obtained from utterance content and voice recognition result.

3. The dialogue system according to claim 1, wherein the utterance feature extraction unit performs determination by using a logistic function that uses normalized features as explanatory variables.

4. The dialogue system according to claim 1, wherein the utterance detection/voice recognition unit is configured to merge utterances with a silent section shorter than or equal to a predetermined time period in between into one utterance.

5. A determination method for a dialogue system including an utterance detection/voice recognition unit and an utterance feature extraction unit to determine whether or not an utterance is directed to the dialogue system, the determination method comprising the steps of:
detecting an utterance and recognizes a voice; and
determining whether or not a target utterance is directed to the dialogue system based on features including a length of the target utterance, time relation between the target utterance and a previous utterance, and a system state.

6. The determination method according to claim 5, wherein the features further include features obtained from utterance content and voice recognition result.

7. The determination method according to claim 5, wherein the step of determining includes determining by using a logistic function that uses normalized features as explanatory variables.

8. The determination method according to claim 5, wherein the step of detecting includes merging utterances with a silent section shorter than or equal to a predetermined time period in between into one utterance.

9. A dialogue system comprising:
means for detecting an utterance and recognizes a voice; and
means for extracting features of an utterance by determining whether or not a target utterance is directed to the dialogue system based on features including a length of the target utterance, time relation between the target utterance and a previous utterance, and a system state.

10. The dialogue system according to claim 9, wherein the features further include features obtained from utterance content and voice recognition result.

11. The dialogue system according to claim 9, wherein the means for extracting features of the utterance performs determination by using a logistic function that uses normalized features as explanatory variables.

12. The dialogue system according to claims 9, wherein the means for detecting the utterance and recognizes the voice merges utterances with a silent section shorter than or equal to a predetermined time period in between into one utterance.
